(19) United States
(12) Patent Application Publication
(10) Pub. No.: US 2026/0133696 A1
(43) Pub. Date: May 14, 2026

(54) MEMORY SYSTEM

(71) Applicant: Kioxia Corporation, Tokyo (JP)

(72) Inventors: Akinori KAMIZONO, Yokohama (JP); Kazutoshi NODA, Kawasaki (JP)

(73) Assignee: Kioxia Corporation, Tokyo (JP)

(21) Appl. No.: 19/071,872

(22) Filed: Mar. 6, 2025

(30) Foreign Application Priority Data
Nov. 13, 2024 (JP) 2024-197995

(51) Int. Cl. G06F 3/06

(52) U.S. Cl. CPC G06F 3/0613; G06F 3/0659; G06F 3/0679

(57) ABSTRACT

According to one embodiment, a memory system including a nonvolatile memory and a controller is provided. The controller can manage the nonvolatile memory in a plurality of management units for garbage collection. The controller determines a first management unit that is a movement destination of data in garbage collection, among the plurality of management units in accordance with respective usage ratios of the plurality of management units.

### CROSS-REFERENCE TO RELATED APPLICATIONS

This application is based upon and claims the benefit of Japanese Patent Application No. 2024-197995, filed on Nov. 13, 2024; the entire contents of which are incorporated herein by reference.

### FIELD

Embodiments described herein relate generally to a memory system.

### BACKGROUND

A memory system including a nonvolatile memory sometimes manages the nonvolatile memory in a plurality of management units. If the data writing into the nonvolatile memory progresses, a management unit including a region made inefficient due to invalid data is generated. Thus, garbage collection of collecting effective data from the management unit made inefficient, rewriting the collected effective data into another management unit, erasing a region in the original management unit that has been made inefficient, and making the region into a free region is performed. The garbage collection is desired to be efficiently performed.

### BRIEF DESCRIPTION OF THE DRAWINGS

FIG. 1 is a diagram illustrating a configuration of a memory system according to a first embodiment;

FIG. 2 is a diagram illustrating a configuration of a controller and a nonvolatile memory according to the first embodiment;

FIG. 3 is a diagram illustrating a data structure of a block management table according to the first embodiment;

FIG. 4 is a flowchart illustrating a schematic operation of the memory system according to the first embodiment;

FIG. 5 is a flowchart illustrating garbage collection (GC) destination search processing of the memory system according to the first embodiment;

FIG. 6 is a diagram illustrating a use case of GC destination search processing of the memory system according to the first embodiment;

FIG. 7 is a diagram illustrating a use case of GC destination search processing of the memory system according to the first embodiment;

FIG. 8 is a diagram illustrating a configuration of a controller and a nonvolatile memory according to a second embodiment;

FIG. 9 is a diagram illustrating a block management table according to the second embodiment;

FIG. 10 is a diagram illustrating a use case of GC destination search processing of the memory system according to the second embodiment;

FIG. 11 is a diagram illustrating a use case of GC destination search processing of the memory system according to the second embodiment;

FIG. 12 is a diagram illustrating a configuration of a controller and a nonvolatile memory according to a third embodiment;

FIG. 13 is a diagram illustrating a block management table according to the third embodiment;

FIG. 14 is a diagram illustrating a use case of GC destination search processing of the memory system according to the third embodiment; and

FIG. 15 is a diagram illustrating a use case of GC destination search processing of the memory system according to the third embodiment.

### DETAILED DESCRIPTION

In general, according to one embodiment, there is provided a memory system including a nonvolatile memory and a controller. The nonvolatile memory includes a plurality of management units. The controller is configured to manage the multiple management units, and determine a first management unit that is a movement destination of data in garbage collection, among the plurality of management units in accordance with respective usage ratios of the plurality of management units.

Exemplary embodiments of a memory system will be explained below in detail with reference to the accompanying drawings. The present invention is not limited to the following embodiments.

### First Embodiment

The memory system according to the first embodiment includes a nonvolatile memory including multiple management units. The memory system performs garbage collection of collecting effective data from a management unit including a region made inefficient due to a large amount of invalid data being written, and rewriting the collected effective data into another management unit, and thereby erasing a region in the original management unit that has been made inefficient, and making the region into a free region. The data movement caused by the garbage collection to be described later refers to copying effective data included in a copy source block, to another block, and erasing data included in the copy source block, for example.

A memory system according to the first embodiment from which copy source data is erased is devised for the purpose of efficiently performing the garbage collection.

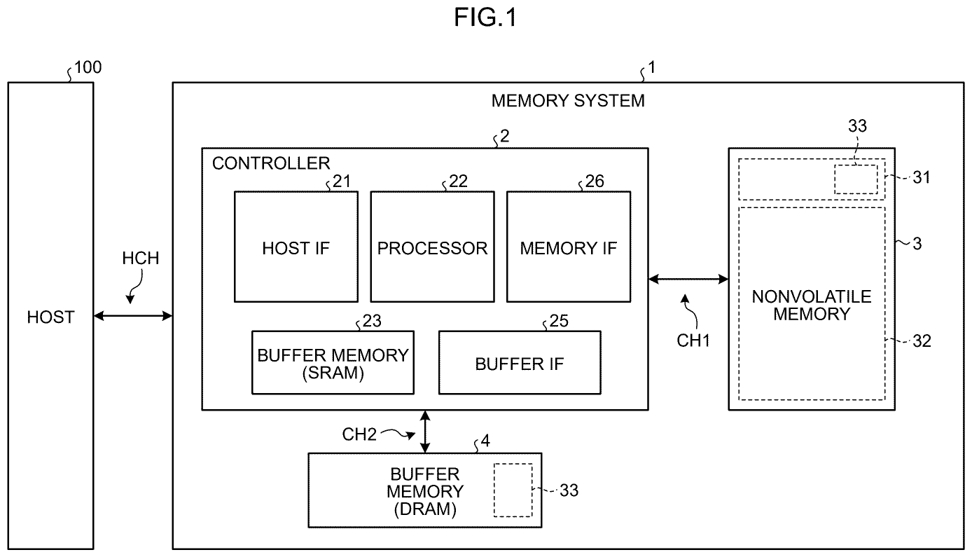

A memory system 1 can have a configuration as illustrated in FIG. 1. FIG. 1 is a diagram illustrating a configuration of the memory system 1.

The memory system 1 can connect to a host 100 via a host channel HCH, and can function as a memory medium for the host 100. The memory system 1 is, for example, a solid state drive (SSD), an embedded multi-media card (eMMC), or a memory card. The host 100 may be a terminal such as a personal computer, or may be a central processing unit (CPU) of a terminal. The host channel HCH may be a cable communication path.

The memory system 1 includes a controller 2, a nonvolatile memory 3, and a buffer memory 4. The controller 2 can connect to the host 100 via the host channel HCH (host channel). The controller 2 is connected to the nonvolatile memory 3 via a channel 1 (CH1). The channel CH1 includes multiple signal lines. The controller 2 is connected to the buffer memory 4 via a channel 2 (CH2). The channel CH2 includes one or more signal lines.

The controller 2 comprehensively controls each component of the memory system 1. The controller 2 can be implemented as a controller package including a system-on-a-chip (SoC), for example. The controller 2 includes a host interface (host IF) 21, a processor 22, a buffer memory 23, a buffer interface (buffer IF) 25, and a memory interface (memory IF) 26.

The host interface 21 can connect to the host 100 via the host channel HCH. The host interface 21 receives commands and data from the host 100, and transmits responses and data to the host 100.

The processor 22 comprehensively controls each component of the controller 2. The processor 22 can be implemented as a central processing unit (CPU) or the like. The processor 22 controls writing processing of writing data into the nonvolatile memory 3, in accordance with a writing command received by the host interface 21. The processor 22 controls reading processing of reading data from the nonvolatile memory 3, in accordance with a reading command received by the host interface 21. The processor 22 controls erasing processing of erase data from the nonvolatile memory 3.

The buffer memory 23 is a volatile memory such as a static random access memory (SRAM), for example, and can be used as a working region of the controller 2. The buffer memory 23 temporarily stores data related to writing processing and reading processing, temporarily stores data of internal processing such as garbage collection, and temporarily stores management information such as logical-to-physical address transformation information to be described later.

The buffer interface 25 performs an interface operation for the buffer memory 4 under the control of the processor 22. The buffer interface 25 can perform transfer of data related to writing processing and reading processing, data of internal processing such as garbage collection, and management information such as logical-to-physical address transformation information, with the buffer memory 4.

The buffer memory 4 is a volatile memory such as a dynamic random access memory (DRAM), for example, and can be used as a working region of the controller 2. The buffer memory 4 temporarily storer data related to writing processing and reading processing, temporarily stores data of internal processing such as garbage collection, and temporarily stores management information such as logical-to-physical address transformation information.

The memory interface 26 performs an interface operation for the nonvolatile memory 3 under the control of the processor 22. The memory interface 26 can perform transfer of data related to writing processing and reading processing, data of internal processing such as garbage collection, and management information such as logical-to-physical address transformation information, with the nonvolatile memory 3.

The nonvolatile memory 3 may be, for example, a negated AND (NAND) flash memory, a resistance random access memory (ReRAM), a phase change RAM (PRAM), a magnetoresistive random access memory (MRAM), or a ferroelectric random access memory (FeRAM). Hereinafter, a case where the nonvolatile memory 3 is an NAND flash memory will be mainly described.

Multiple media blocks is allocated to the nonvolatile memory 3 by the controller 2. A partial media block of the multiple media blocks is allocated to a management information storage region 31, and remaining (most) media blocks are allocated to a storage region 32. Each media block includes multiple media pages. The storage region 32 is a region in which data requested by the host 100 to be written is stored, and the management information storage region 31 is a region in which management information regarding management to be executed by the controller 2 is stored.

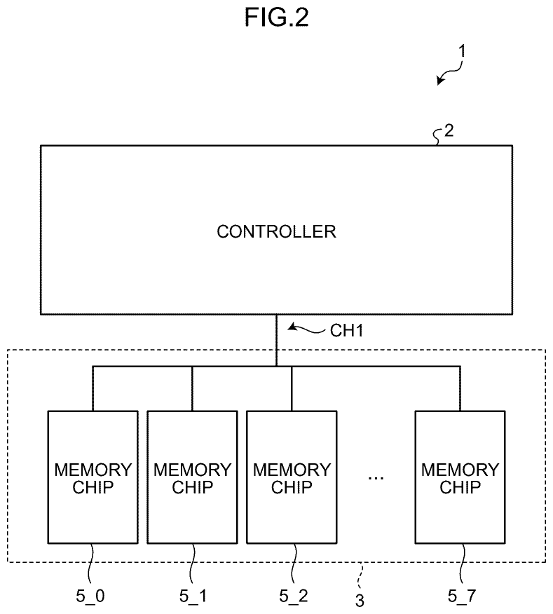

As illustrated in FIG. 2, the nonvolatile memory 3 includes multiple memory chips 5_0 to 5_7. FIG. 2 is a diagram illustrating a configuration of the controller 2 and the nonvolatile memory 3. In addition, the number of memory chips 5 included in the nonvolatile memory 3 is not limited to eight exemplified in FIG. 2, and may be seven or less or may be nine or more.

The controller 2 is connected to the multiple memory chips 5_0 to 5_7 via the channel CH1.

In each memory chip 5, a unit in which data writing/reading access can be collectively performed is a physical page. Multiple physical pages in which writing/reading can be almost collectively performed in parallel may constitute one media page serving as a data recording region.

A minimum access unit including multiple physical pages, in which data erasing can be independently performed is a physical block. Multiple physical blocks in which data can be almost collectively erased in parallel may constitute one media block serving as a data block.

Each physical block includes multiple memory cells. Each memory cell can execute multi-level storing. In a case where each memory cell in a memory cell group connected to the same word line in each physical block can store n-bit information, the memory cell group is handled as n physical pages.

For example, in a case where a memory cell is used in a single level cell (SLC) mode (in the case of n=1), within a range in which a threshold voltage is controlled, two states (small regions) ST0 to ST1 exist in a threshold voltage distribution of the memory cell.

In a case where the memory cell is used in a multiple level cell (MLC) (in the case of n=2), within a range in which a threshold voltage is controlled, four states ST0 to ST3 exist in a threshold voltage distribution of the memory cell.

In a case where the memory cell is used in a triple level cell (TLC) mode (in the case of n=3), within a range in which a threshold voltage is controlled, eight states ST0 to ST7 exist in a threshold voltage distribution of the memory cell.

In a case where the memory cell is used in a quad level cell (QLC) mode (in the case of n=4), within a range in which a threshold voltage is controlled, 16 states ST0 to ST15 exist in a threshold voltage distribution of the memory cell.

In a case where the memory cell is used in a penta level cell (PLC) mode (in the case of n=5), within a range in which a threshold voltage is controlled, 32 states ST0 to ST31 exist in a threshold voltage distribution of the memory cell.

Hereinafter, a media block will be simply called a block, and a media page will be simply called a page.

Here, the management of a physical address and a logical address in the nonvolatile memory 3 will be described. The physical address is an address indicating a storage position in the nonvolatile memory 3. This storage position will also be referred to as a physical storage position. The physical address will be referred to as a physical block address (PBA), a memory block address (MBA), or the like. The logical-to-physical address transformation information is a table managing a correspondence relationship between a logical address and a physical address. The logical-to-physical address transformation information manages a correspondence relationship between a logical address and a physical address for each page, for example.

Data writing into one page of one memory cell can be performed once for one program/erasing cycle (P/E cycle), and additional writing is not allowed until data is erased. For this reason, the controller 2 writes update data corresponding to a certain logical address, not into a physical storage position where previous data corresponding to this logical address is stored, but into a different physical storage position. Then, the controller 2 invalidates the previous data by updating logical-to-physical address transformation information in such a manner as to associate this logical address with this different physical storage position. Data referred to from the logical-to-physical address transformation information (i.e., data associated with the logical address) will be referred to as effective data. Further, data associated with none of logical addresses will be referred to as invalid data. The effective data is data having a possibility of being read from the host 100 later. The invalid data is data having no possibility of being read from the host 100.

The garbage collection to be executed by the controller 2 will be described. When performing garbage collection, the controller 2 may be enabled to manage the nonvolatile memory 3 for each of the memory chips 5.

For example, the controller 2 may determine a management unit having a vacant capacity that is a threshold value Cth or less, among multiple management units, to be a movement source of data in the garbage collection. The vacant capacity refers to an amount of invalid data in the management unit. For example, the controller 2 may determine a management unit having the number of vacant blocks that is a threshold value Nth or less, among multiple management units, to be a movement source of data in the garbage collection. The vacant block refers to a block in which all pieces of data written therein are pieces of invalid data. The controller 2 may convert the vacant capacity into the number of vacant blocks converted into that in the TLC mode, and manage the converted number of vacant blocks.

The controller 2 may determine a management unit having a used capacity that is a threshold value Ctha or more, among multiple management units, to be a movement source of data in the garbage collection. The used capacity refers to an amount of effective data in the management unit. For example, the controller 2 may determine a management unit having the number of used blocks that is a threshold value Ntha or more, among multiple management units, to be a movement source of data in the garbage collection. The used block refers to a block in which written data includes effective data. The controller 2 may convert the used capacity into the number of used blocks converted into that in the TLC mode, and manage the converted number of used blocks.

The controller 2 may determine a management unit serving as a movement destination of data in the garbage collection, among multiple management units in accordance with the respective usage ratios of the multiple management units. In the first embodiment, the controller 2 determines a management unit having the minimum usage ratio among the multiple management units, to be a movement destination of data in the garbage collection.

The controller 2 may manage the number of blocks that can be used by a user in each memory chip 5, as the maximum number of user blocks. The controller 2 may manage the maximum number of user blocks, as the number of blocks converted into that in the TLC mode.

The controller 2 may manage the number of blocks used in each memory chip 5, as the number of used blocks. The controller 2 may manage the number of used blocks, as the number of blocks converted into that in the TLC mode.

The controller 2 manages a percentage of blocks used in each memory chip 5, as a usage ratio. The usage ratio is calculated using the number of used blocks and the maximum number of user blocks. For example, the controller 2 may obtain the usage ratio by dividing the number of used blocks by the maximum number of user blocks.

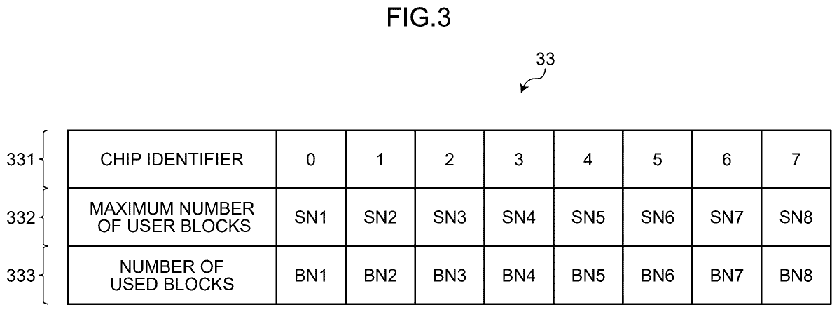

The controller 2 may perform the garbage collection using a block management table 33 as illustrated in FIG. 3. The block management table 33 is stored in the management information storage region 31. FIG. 3 is a diagram illustrating a data structure of the block management table 33.

The block management table 33 includes a chip identifier field 331, a maximum number of user blocks field 332, and a number of used blocks field 333. In the block management table 33, identifiers of the memory chips 5, the maximum numbers of user blocks, and the numbers of used blocks are associated with the multiple memory chips 5_0 to 5_7. In the chip identifier field 331, the identifiers of the memory chips 5 are recorded. In the maximum number of user blocks field 332, the maximum numbers of user blocks of the memory chips 5 are recorded. In the number of used blocks field 333, the number of used blocks of the memory chips 5 are recorded.

By referring to the block management table 33, the controller 2 can recognize the maximum number of user blocks and the number of used blocks of a memory chip 5 corresponding to an identifier. The controller 5 can obtain a usage ratio of each memory chip 5 with reference to the block management table 33.

Regarding the memory chip 5_0 with a chip identifier “0”, the maximum number of user blocks is “SN1” and the number of used blocks is “BN1”. From these numbers, a usage ratio of the memory chip 5_0 can be obtained as (BN1)/(SN1).

Regarding the memory chip 5_1 with a chip identifier “1”, the maximum number of user blocks is “SN2” and the number of used blocks is “BN2”. From these numbers, a usage ratio of the memory chip 5_1 can be obtained as (BN2)/(SN2).

Regarding the memory chip 5_7 with a chip identifier “7”, the maximum number of user blocks is “SN8” and the number of used blocks is “BN8”. From these numbers, a usage ratio of the memory chip 5_7 can be obtained as (BN8)/(SN8).

As illustrated in FIG. 1, the block management table 33 is stored in the management information storage region 31 of the nonvolatile memory 3. When the memory system 1 is activated or the like, the controller 2 may read the block management table 33 from the management information storage region 31, and store the read block management table 33 into the buffer memory 4.

The controller 2 updates the block management table 33 on the buffer memory 4 at a predetermined timing. The predetermined timing is a timing at which writing/erasing access to the storage region 32 of the nonvolatile memory 3 occurs, for example.

The controller 2 may write the block management table 33 from the buffer memory 4 back into the management information storage region 31 at the predetermined timing, and make the block management table 33 involatile. The predetermined timing may be a periodic timing that is based on the lapse of time, or may be a timing of shutdown of the memory system 1.

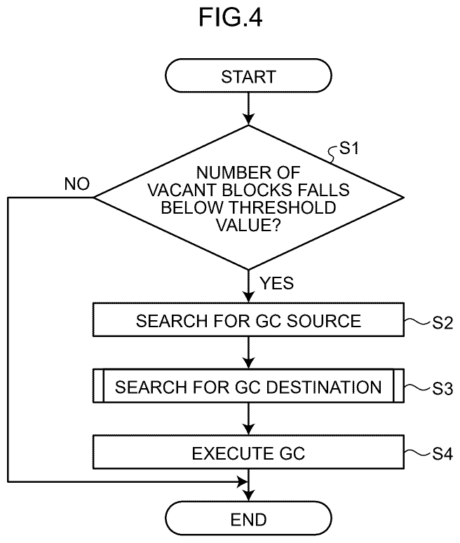

Next, a schematic operation of the memory system 1 in the garbage collection will be described using FIG. 4. FIG. 4 is a flowchart illustrating a schematic operation of the memory system 1.

In the memory system 1, the controller 2 determines whether or not multiple management units includes a management unit having the number of vacant blocks that is smaller than the threshold value Nth (S1). The threshold value Nth is a value determined in consideration of a margin of the number of vacant blocks in such a manner that data loss does not occur in the management unit. The threshold value Nth can be experimentally predetermined before the shipment of the memory system 1. The management unit is one memory chip of the multiple memory chips 5_0 to 5_7, for example. The multiple management units is the multiple memory chips 5_0 to 5_7.

The controller 2 obtains the number of vacant blocks by subtracting the number of used blocks from the maximum number of user blocks with reference to the block management table 33. By comparing the obtained number of vacant blocks with the threshold value Nth, the controller 2 determines whether or not a management unit having the number of vacant blocks that is smaller than the threshold value Nth exists.

If a management unit having the number of vacant blocks that is smaller than the threshold value Nth does not exist (No in S1), the controller 2 ends the processing illustrated in this flowchart.

If a management unit having the number of vacant blocks that is smaller than the threshold value Nth exists (Yes in S1), the controller 2 performs garbage collection (GC) source search processing of searching for a management unit serving as a movement source (GC source) of data in the garbage collection (S2).

Instead of a management unit having the number of vacant blocks that is smaller than the threshold value Nth, the controller 2 may determine a management unit having the number of vacant blocks that is the threshold value Nth or less, as a GC source. In a case where two or more management units having the numbers of vacant blocks that are the threshold value Nth or less exist among the multiple management units, the controller 2 may determine a management unit with a smaller number of vacant blocks out of the two or more management units, as a GC source.

The controller 2 performs GC destination search processing of searching for a management unit serving as a movement destination (GC destination) of data in the garbage collection (S3). For example, the controller 2 determines a management unit serving as a GC destination, from among multiple management units in accordance with the respective usage ratios of the multiple management units. For example, the controller 2 determines a management unit having the minimum usage ratio among the multiple management units, as a GC destination.

The controller 2 executes the garbage collection (GC) (S4). The controller 2 collects effective data from a block in the management unit found in S2 that has been made inefficient, and rewrites the collected effective data into the management unit found in S3. The controller 2 erases the block in the management unit found in S2 that has been made inefficient, and makes the block into a free block.

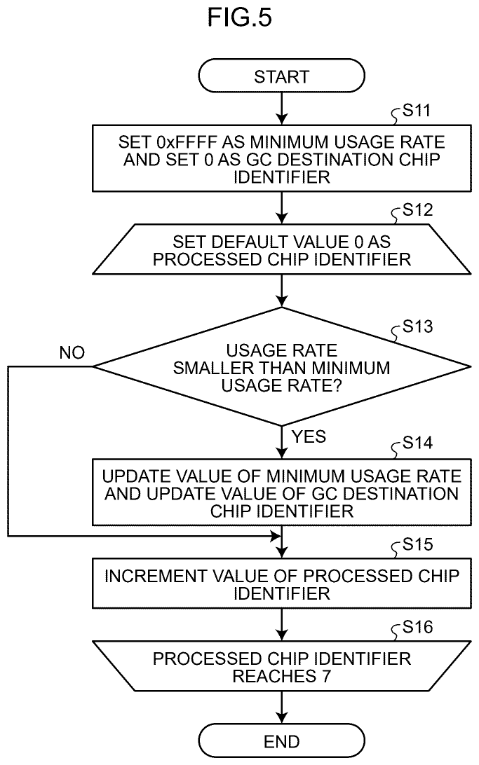

Next, GC destination search processing (S3) will be described using FIG. 5. FIG. 5 is a flowchart illustrating GC destination search processing of the memory system 1. FIG. 5 exemplifies a case where multiple management units to be searched for a GC destination is multiple memory chips 5_0 to 5_7.

In the memory system 1, the controller 2 sets a default value as a parameter for executing the GC destination search processing. The parameter includes a minimum usage ratio and a CG destination chip identifier. The minimum usage ratio is a parameter for determining whether or not a usage ratio of the memory chip 5 is minimum. The GC destination chip identifier is a parameter for identifying a memory chip to be set as a GC destination.

The controller 2 sets a default value “0xFFFF” as a minimum usage ratio, and sets a default value “0” as a GC destination chip identifier.

The controller 2 performs loop processing in S13 to S15. The controller 2 may use a processed chip identifier as a parameter for managing the loop processing in S13 to S15. The controller 2 sets a default value “0” as a processed chip identifier (S12), and starts the loop processing in S13 to S15.

The controller 2 determines whether or not a usage ratio of a memory chip 5 to be processed is smaller than the minimum usage ratio (S13).

If a usage ratio of a memory chip 5 to be processed is equal to or larger than the minimum usage ratio (No in S13), the controller 2 determines that the memory chip 5 to be processed is inappropriate as a GC destination, and advances the processing to S15.

If the usage ratio of the memory chip 5 to be processed is smaller than the minimum usage ratio (Yes in S13), the controller 2 determines that the memory chip 5 to be processed might be appropriate as a GC destination, and updates the value of the minimum usage ratio of the parameter and the value of the GC destination chip identifier of the parameter (S14). That is, the controller 2 sets the usage ratio of the memory chip 5 to be processed, as a value of the minimum usage ratio, and sets a chip identifier of the memory chip 5 to be processed, as a GC destination chip identifier.

The controller 2 increments the value of the processed chip identifier (S15). After S15, the processing returns to S13.

The loop in S13 to S15 is repeated until the processed chip identifier reaches 7. If the processed chip identifier reaches 7, after steps S13 to S16 are executed on the memory chip 5_7 with the chip identifier “7”, the processing is ended.

Through the processing illustrated in FIG. 5, an identifier of the memory chip 5 having the minimum usage ratio among the multiple memory chips 5_0 to 5_7 is set as a GC destination chip identifier. The memory chip 5 corresponding to the identifier set as the GC destination chip identifier is thereby selected as a GC destination memory chip. Through the above-described processing, it is possible to suppress the generation of a memory chip 5 with an excessively-high usage ratio, and uniformize usage ratios (for example, block usage ratios) of the multiple memory chips 5_0 to 5_7.

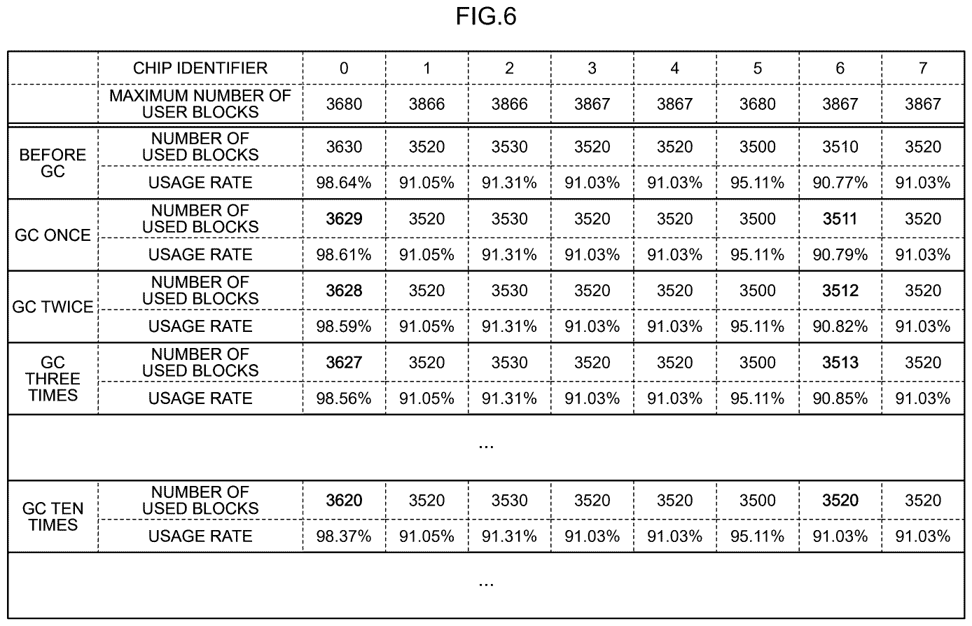

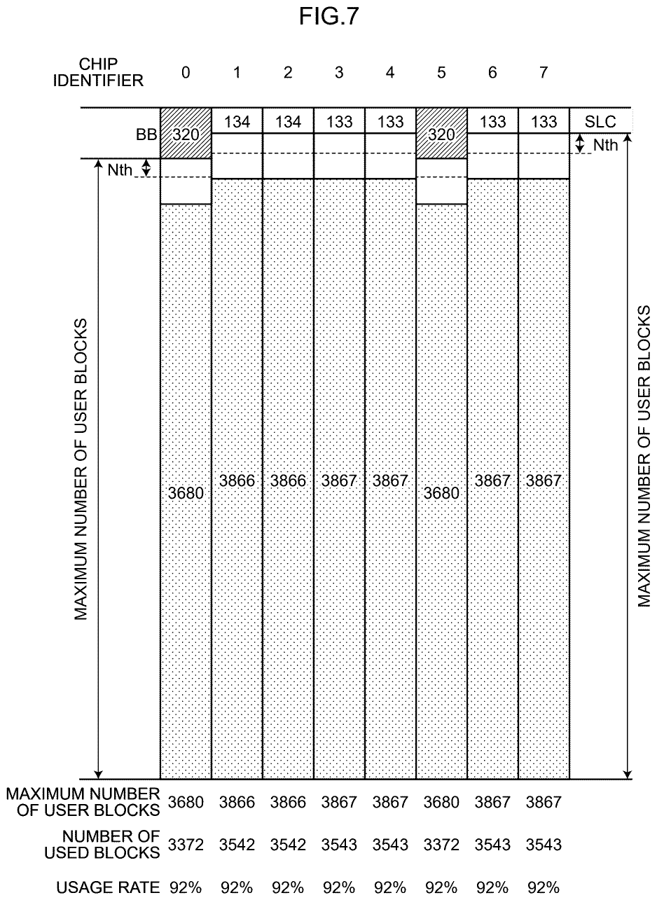

Next, a use case of the GC destination search processing of the memory system 1 will be described using FIGS. 6 and 7. FIGS. 6 and 7 are diagrams each illustrating a use case of the GC destination search processing of the memory system 1.

FIG. 6 illustrates a table indicating the maximum number of user blocks of each memory chip, and a usage ratio and the number of used blocks that change in accordance with the number of times of GC.

In the state “before GC” illustrated in FIG. 6, the numbers of vacant blocks of multiple memory chips 5_0, 5_1, 5_2, 5_3, 5_4, 5_5, 5_6, and 5_7 are 3680−3630=50, 3866−3520=346, 3866−3530=336, 3867−3520=347, 3867−3520=347, 3680−3500=180, 3867−3510=357, and 3867−3520=347, respectively.

Among the multiple memory chips 5_0 to 5_7, the memory chip 5_0 with a smaller number of vacant blocks out of the memory chips 5_0 and 5_5 having the numbers of vacant blocks that are smaller than the threshold value Nth (for example, Nth=300) is determined to be a GC source.

As illustrated in “before GC”, in a state in which GC has not been performed, usage ratios of the multiple memory chips 5_0, 5_1, 5_2, 5_3, 5_4, 5_5, 5_6, and 5_7 are 98.64%, 91.05%, 91.31%, 91.03%, 91.03%, 95.11%, 90.77%, and 91.03%, respectively.

Among the multiple memory chips 5_0 to 5_7, the memory chip 5_6 having the minimum usage ratio is determined to be a GC destination.

The controller 2 collects effective data from a block in the memory chip 5_0 that has been made inefficient, and rewrites the collected effective data into the memory chip 5_6. The controller 2 erases the block in the memory chip 5_0 that has been made inefficient, and makes the block into a free block. The free block is also called a vacant block.

Accordingly, the numbers of used blocks and usage ratios of the multiple memory chips enter a state in which GC has been performed once, as indicated in “GC once”. In this state, the usage ratios of the multiple memory chips 5_0, 5_1, 5_2, 5_3, 5_4, 5_5, 5_6, and 5_7 are 98.61%, 91.05%, 91.31%, 91.03%, 91.03%, 95.11%, 90.79%, and 91.03%, respectively.

In the state in which GC has not been performed, a difference between the maximum usage ratio and the minimum usage ratio of the multiple memory chips is 98.64−90.77=7.87 (%). A difference between the maximum usage ratio and the minimum usage ratio of the multiple memory chips in the state in which GC has been performed once is 98.61−90.79=7.82 (%).

In other words, by the GC being performed once, a difference between the maximum usage ratio and the minimum usage ratio of the multiple memory chips 5_0 to 5_7 decreases, and usage ratios are uniformized.

In a state in which GC has been performed ten times, as indicated in “GC ten times”, the usage ratios of the multiple memory chips 5_0, 5_1, 5_2, 5_3, 5_4, 5_5, 5_6, and 5_7 are 98.37%, 91.05%, 91.31%, 91.03%, 91.03%, 95.11%, 91.03%, and 91.03%, respectively.

In the state in which GC has been performed ten times, a difference between the maximum usage ratio and the minimum usage ratio of the multiple memory chips is 98.37−91.03=7.34 (%).

In other words, by the controller 2 performing the GC ten times, a difference between the maximum usage ratio and the minimum usage ratio of the multiple memory chips 5_0 to 5_7 further decreases, and usage ratios are further uniformized.

FIG. 7 is a diagram illustrating usage states of multiple memory chips in a case where the number of times of GC is further increased in the first embodiment. In FIG. 7, the usage states of the memory chips 5_0 to 5_7 are indicated as bar graphs. In FIG. 7, a vertical axis indicates the number of blocks, and a horizontal axis indicates a chip identifier. If the number of times of GC is increased, for example, as illustrated in FIG. 7, the usage ratios of the multiple memory chips 5_0 to 5_7 become 92%, and can become almost equal.

Regions “320” in the memory chips 5_0 and 5_5 are made inaccessible as bad blocks BB. The bad block BB is a block made unusable due to a bit error ratio exceeding a predetermined value. In each of the memory chips 5_0 and 5_5, “3680” corresponding to the total number of blocks excluding the number of bad blocks “320” is the maximum number of user blocks.

Regions “134” in the memory chips 5_1 and 5_2 are made inaccessible as being a part of the management information storage region 31 (refer to FIG. 1). The management information storage region 31 includes multiple memory cells to be used in the SLC mode. In each of the memory chips 5_1 and 5_2, “3866” corresponding to the total number of blocks excluding the number of blocks “134” of the management information storage region is the maximum number of user blocks.

Regions “133” in the memory chips 5_3, 5_4, 5_6, and 5_7 are made inaccessible as being a part of the management information storage region 31 (refer to FIG. 1). In each of the memory chips 5_3, 5_4, 5_6, and 5_7, “3867” corresponding to the total number of blocks excluding the number of blocks “133” of the management information storage region is the maximum number of user blocks.

In each of the memory chips 5_0 to 5_7, a part indicated by dot hatching corresponds to the number of used blocks. A white part in each of the memory chips 5_0 to 5_7 corresponds to the number of vacant blocks. A part existing above a dotted line in the white part in each of the memory chips 5_0 to 5_7 corresponds to the threshold value Nth of the number of vacant blocks at which the GC is executed. As illustrated in FIG. 7, in the memory system of the first embodiment, the number of blocks existing between a part indicated by dot hatching, and a dotted line indicating a threshold value becomes equal, and the numbers of vacant blocks of the multiple memory chips become equal to each other. In other words in the multiple memory chips, margins in the number of blocks up to the GC executed become equal. With this configuration, it is possible to equalize the frequency of executing the GC among multiple memory chips 5_0 to 5_7.

In other words, by using a usage ratio as a criterion for determining a GC destination, a memory chip 5 with a large number of bad blocks becomes less likely to be selected as a GC destination because a usage ratio is high even if the number of used blocks is small. The frequency of executing the GC is reduced. Furthermore, a memory chip 5 with a smaller number of bad blocks becomes more likely to be selected as a GC destination because a usage ratio is low even if the number of used blocks is large. For this reason, it becomes possible to suppress an increase in the number of times of writing/erasing in each memory chip 5, and it is possible to prolong a product lifetime.

As described above, in the first embodiment, in the memory system 1, the controller 2 determines a management unit serving as a movement destination of data in the garbage collection, among multiple management units in accordance with the respective usage ratios of the multiple management units. Accordingly, it is possible to uniformize the respective usage ratios of multiple management units, equalize the frequency of executing garbage collection among the multiple management units, and efficiently perform the garbage collection. Consequently, it is possible to equalize the number of times of writing/erasing among the multiple management units, and equalize the respective exhaustion degrees of the multiple management units. Accordingly, it is possible to make the lifetime of the memory system 1 longer.

Further, in the first embodiment, when the garbage collection is performed in the memory system 1, the controller can manage the nonvolatile memory 3 for each of the memory chips 5. In other words, the controller 2 determines a memory chip 5 serving as a movement destination of data in the garbage collection, among multiple memory chips 5 in accordance with the respective usage ratios of the multiple memory chips 5. Accordingly, it is possible to uniformize the respective usage ratios of the memory chips 5 among the multiple memory chips 5, equalize the frequency of executing garbage collection among the multiple memory chips 5, and efficiently perform garbage collection. Consequently, it is possible to equalize the number of times of writing/erasing among the multiple memory chips 5, and equalize the respective exhaustion degrees of the multiple memory chips 5. Accordingly, it is possible to make the lifetime of the memory system 1 longer.

It should be noted that, instead of performing the garbage collection in accordance with the respective block usage ratios of management units, the controller 2 may perform the garbage collection in accordance with the respective page usage ratios of management units. Instead of using a block as a management unit, the controller 2 may use a page as a management unit.

The controller 2 may manage the number of pages that can be used by the user in each memory chip 5, as the maximum number of pages.

The controller 2 may manage the number of pages used in each memory chip 5, as the number of used pages. The used page refers to a page on which written data includes effective data.

The controller 2 may manage a percentage of pages used in each memory chip 5, as a usage ratio. The usage ratio is calculated using the number of used pages and the maximum number of pages. For example, the controller 2 may obtain the usage ratio by dividing the number of used pages by the maximum number of pages.

The controller 2 may perform the garbage collection using a block management table 33′ in which the maximum number of user blocks and the number of used blocks in the block management table 33 illustrated in FIG. 3 are replaced with an upper limit number of pages and the number of used pages.

In S1 illustrated in FIG. 4, the controller 2 may determine whether or not multiple management units includes a management unit having the number of blank pages that is smaller than a threshold value PNth. The threshold value PNth is a value determined in consideration of a margin of the number of blank pages in such a manner that data loss does not occur in the management unit. The threshold value PNth can be experimentally predetermined before the shipment of the memory system 1.

Alternatively, in S1 illustrated in FIG. 4, the controller 2 may determine whether or not multiple management units includes a management unit of which the number of used blocks exceeds the threshold value Ntha. The threshold value Ntha is a value determined in consideration of a margin of the number of used blocks in such a manner that data loss does not occur in the management unit. The threshold value Ntha can be experimentally predetermined before the shipment of the memory system 1.

Alternatively, in S1 illustrated in FIG. 4, the controller 2 may determine whether or not multiple management units includes a management unit of which the number of used pages exceeds a threshold value PNtha. The threshold value PNtha is a value determined in consideration of a margin of the number of used pages in such a manner that data loss does not occur in the management unit. The threshold value Ntha can be experimentally predetermined before the shipment of the memory system 1.

Alternatively, in S1 illustrated in FIG. 4, the controller 2 may determine whether or not multiple management units includes a management unit of which a usage ratio exceeds a threshold value Rth. The threshold value Rth can be experimentally predetermined in consideration of a margin of a usage ratio in such a manner that data loss does not occur in the management unit.

### Second Embodiment

Next, a memory system 1i according to the second embodiment will be described. Hereinafter, a part different from the first embodiment will be mainly described.

While garbage collection that uses a memory chip as a management unit is exemplified in the first embodiment, garbage collection that uses a parallel processing unit in a memory chip as a management unit is exemplified in the second embodiment.

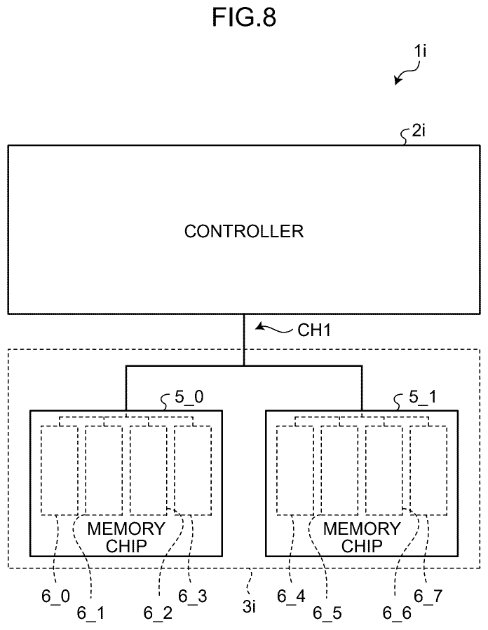

As illustrated in FIG. 8, in a nonvolatile memory 3i of the memory system 1i, each memory chip 5 may include multiple memory areas 6 in which parallel processing can be mutually performed in the memory chip 5. FIG. 8 is a diagram illustrating a configuration of a controller 2i and the nonvolatile memory 3i according to the second embodiment.

The nonvolatile memory 3i includes multiple memory chips 5_0 and 5_1. In FIG. 8, a configuration in which the nonvolatile memory 3i includes the two memory chips 5_0 and 5_1 is exemplified, but the number of memory chips 5 included in the nonvolatile memory 3i may be three or more.

The memory chip 5_0 includes multiple memory areas 6_0 to 6_3. The multiple memory areas 6_0 to 6_3 corresponds to a unit in which parallel processing can be mutually performed in the memory chip 5_0. The controller 2i can access the multiple memory areas 6_0 to 6_3 in the memory chip 5_0 in parallel. Each memory area 6 is also called a plane.

In FIG. 8, a configuration in which the memory chip 5_0 includes the four memory areas 6_0 to 6_3 is exemplified, but the number of memory areas 6 included in the memory chip 5_0 may be two to three, or may be five or more.

The memory chip 5_1 includes multiple memory areas 6_4 to 6_7. The multiple memory areas 6_4 to 6_7 corresponds to a unit in which parallel processing can be mutually performed in the memory chip 5_1. The controller 2i can access the multiple memory areas 6_4 to 6_7 in the memory chip 5_0 in parallel. Each memory area 6 is also called a plane.

In FIG. 8, a configuration in which the memory chip 5_1 includes the four memory areas 6_4 to 6_7 is exemplified, but the number of memory areas 6 included in the memory chip 5_1 may be two to three, or may be five or more.

The controller 2i can manage the nonvolatile memory 3i in a unit of the multiple memory areas 6_0 to 6_7 for garbage collection.

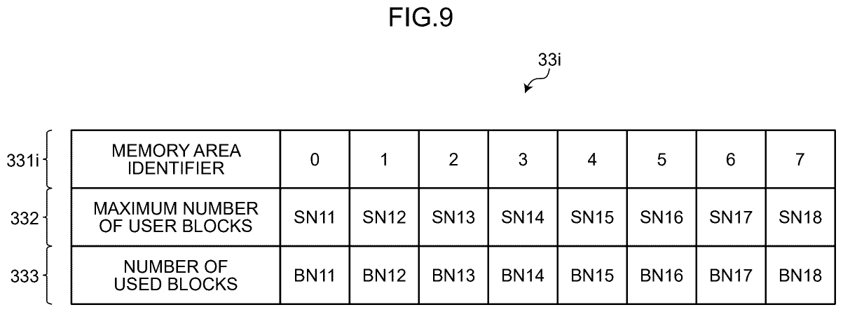

The controller 2i may perform the garbage collection using a block management table 33i as illustrated in FIG. 9, in place of the block management table 33 (refer to FIG. 3). FIG. 9 is a diagram illustrating a data structure of the block management table 33i.

In the block management table 33i, identifiers of the memory areas 6, the maximums number of user blocks, and the numbers of used blocks are associated with the multiple memory areas 6_0 to 6_7. The block management table 33i includes a memory area identifier field 331i in place of the chip identifier field 331 (refer to FIG. 3). In the memory area identifier field 331i, identifiers of the memory areas 6 are recorded. Except for this, the block management table 33i is similar to the block management table 33 of the first embodiment.

By referring to the block management table 33i, it is possible to recognize the maximum number of user blocks and the number of used blocks that correspond to an identifier of a memory area 6, and obtain a usage ratio from the maximum number of user blocks and the number of used blocks.

Regarding the memory area 6_0 with a memory area identifier “0” the maximum number of user blocks is “SN11” and the number of used blocks is “BN11”. From these numbers, a usage ratio can be obtained as (BN11)/(SN11).

Regarding the memory area 6_1 with a memory area identifier “1”, the maximum number of user blocks is “SN12” and the number of used blocks is “BN12”. From these numbers, a usage ratio can be obtained as (BN12)/(SN12).

Regarding the memory area 6_7 with a memory area identifier “7”, the maximum number of user blocks is “SN18” and the number of used blocks is “BN18”. From these numbers, a usage ratio can be obtained as (BN18)/(SN18).

It should be noted that an operation of the memory system 1i in the garbage collection is similar to an operation in which a “memory chip” is replaced with a “memory area” in the description given with reference to FIGS. 4 and 5.

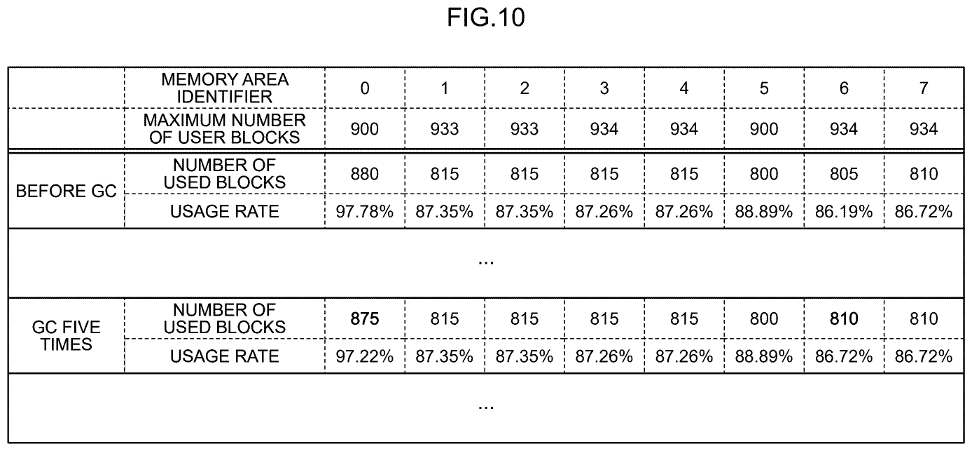

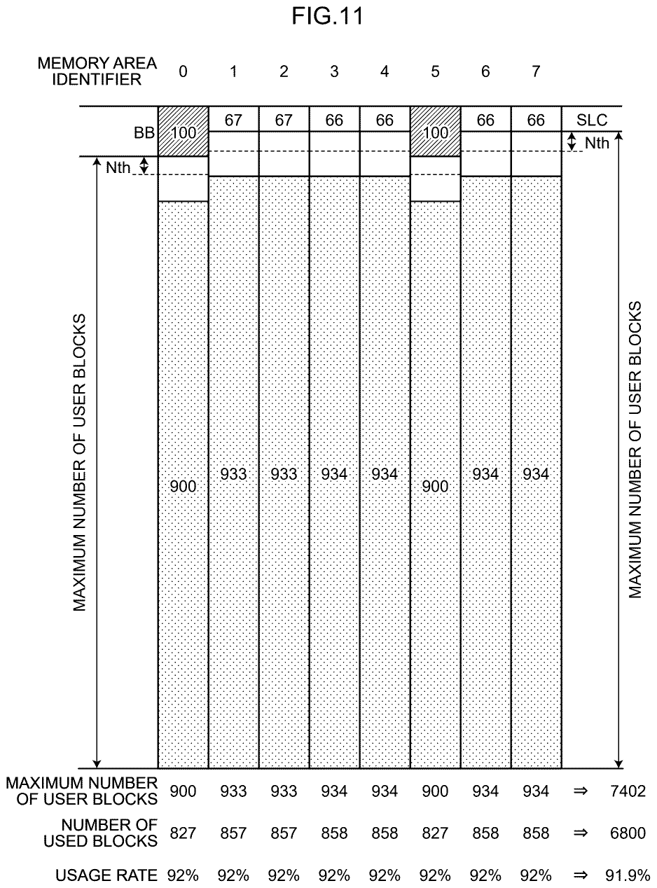

Further, as illustrated in FIGS. 10 and 11, a use case of GC destination search processing of the memory system 1i differs from that in the first embodiment in the following point. FIGS. 10 and 11 are diagrams each illustrating a use case of the GC destination search processing of the memory system 1i according to the second embodiment.

In the state “before GC” illustrated in FIG. 10, the numbers of vacant blocks of multiple memory areas 6_0, 6_1, 6_2, 6_3, 6_4, 6_5, 6_6, and 6_7 are 900−880=20, 933−815=118, 933−815=118, 934−815=119, 934−815=119, 900−800=100, 934−805=129, and 934−810=124, respectively.

Among the multiple memory areas 6_0 to 6_7, the memory area 6_0 having the number of vacant blocks that is smaller than the threshold value Nth (for example, Nth=100) is determined to be a GC source.

As illustrated in “before GC”, in a state in which GC has not been performed, usage ratios of the multiple memory areas 6_0, 6_1, 6_2, 6_3, 6_4, 6_5, 6_6, and 6_7 are 97.78%, 87.35%, 87.35%, 87.26%, 87.26%, 88.89%, 86.19%, and 86.72%, respectively.

Among the multiple memory areas 6_0 to 6_7, the memory area 6_6 having the minimum usage ratio is determined to be a GC destination.

The controller 2i collects effective data from a block in the memory area 6_0 that has been made inefficient, and rewrites the collected effective data into the memory area 6_6. The controller 2i erases the block in the memory area 6_0 that has been made inefficient, and makes the block into a free block.

By repeating similar processing five times, a state of “GC five times” is caused. In this state, the usage ratios of the multiple memory areas 6_0, 6_1, 6_2, 6_3, 6_4, 6_5, 6_6, and 6_7 are 97.22%, 87.35%, 87.35%, 87.26%, 87.26%, 88.89%, 86.72%, and 86.72%, respectively.

A difference between the maximum usage ratio and the minimum usage ratio in the state “before GC” is 97.78−86.19=11.59 (%). As indicated in “GC five times”, a difference between the maximum usage ratio and the minimum usage ratio in the state in which GC has been performed five times is 97.22−86.72=10.5 (%).

In other words, by the controller 2i performing the GC five times, a difference between the maximum usage ratio and the minimum usage ratio in the multiple memory areas 6_0 to 6_7 decreases, and usage ratios are uniformized.

If the GC is further performed, as illustrated in FIG. 11, the usage ratios of the multiple memory areas 6_0 to 6_7 become 92% and can become almost equal. In FIG. 11, the usage states of the memory areas 6_0 to 6_7 are indicated as bar graphs. In FIG. 11, a vertical axis indicates the number of blocks, and a horizontal axis indicates a memory area identifier.

Regions “100” in the memory areas 6_0 and 6_5 are made inaccessible as bad blocks BB. In each of the memory areas 6_0 and 6_5, “900” corresponding to the total number of blocks excluding the number of bad blocks “100” is the maximum number of user blocks.

Regions “67” in the memory area 6_1 and 6_2 are made inaccessible as being a part of the management information storage region 31 (refer to FIG. 1). In each of the memory area 6_1 and 6_2, “933” corresponding to the total number of blocks excluding the number of blocks “67” of the management information storage region is the maximum number of user blocks.

Regions “66” in the memory area 6_3, 6_4, 6_6, and 6_7 are made inaccessible as being a part of the management information storage region 31 (refer to FIG. 1). In each of the memory area 6_3, 6_4, 6_6, and 6_7, “934” corresponding to the total number of blocks excluding the number of blocks “66” of the management information storage region is the maximum number of user blocks.

In each of the memory areas 6_0 to 6_7, a part indicated by dot hatching corresponds to the number of used blocks. A white part in each of the memory areas 6_0 to 6_7 corresponds to the number of vacant blocks. A part existing above a dotted line in the white part in each of the memory areas 6_0 to 6_7 corresponds to the threshold value Nth of the number of vacant blocks at which the GC is executed. As illustrated in FIG. 11, in the memory system of the second embodiment, the number of blocks existing between a part indicated by dot hatching, and a dotted line indicating a threshold value becomes equal, and margins in the number of blocks up to the GC executed become equal. With this configuration, it is possible to equalize the frequency of CG among multiple memory areas 6_0 to 6_7.

In other words, by using a usage ratio as a criterion for determining a GC destination, a memory area 6 with a large number of bad blocks becomes less likely to be selected as a GC destination, because a usage ratio is high even if the number of used blocks is small. The frequency of executing GC is reduced. Furthermore, a memory area 6 with a smaller number of bad blocks becomes more likely to be selected as a GC destination because a usage ratio is low even if the number of used blocks is large. For this reason, it becomes possible to suppress an increase in the number of times of writing/erasing in each memory area 6, and it is possible to prolong a product lifetime.

As described above, in the second embodiment, in the memory system 1i, the controller 2i can manage the nonvolatile memory 3i in a parallel processing unit in the memory chip 5 for the garbage collection. In other words, the controller 2i determines a memory area 6 serving as a movement destination of data in the garbage collection, from among multiple memory areas 6 in accordance with the respective usage ratios of the multiple memory areas 6. Accordingly, it is possible to uniformize the respective usage ratios of the multiple memory areas 6, equalize the frequency of executing garbage collection among the multiple memory areas 6, and efficiently perform the garbage collection. Consequently, it is possible to equalize the number of times of writing/erasing among the multiple memory areas 6, and equalize the respective exhaustion degrees of the multiple memory areas 6. Accordingly, it is possible to make the lifetime of the memory system 1i longer.

### Third Embodiment

Next, a memory system 1j according to the third embodiment will be described. Hereinafter, a part different from the first embodiment and the second embodiment will be mainly described.

While garbage collection that uses a memory chip 5 as a management unit is exemplified in the first embodiment and garbage collection that uses a parallel processing unit in a memory chip 5 as management unit is exemplified in the second embodiment, garbage collection that uses a parallel processing unit existing across two or more memory chips 5, as a management unit is exemplified in the third embodiment.

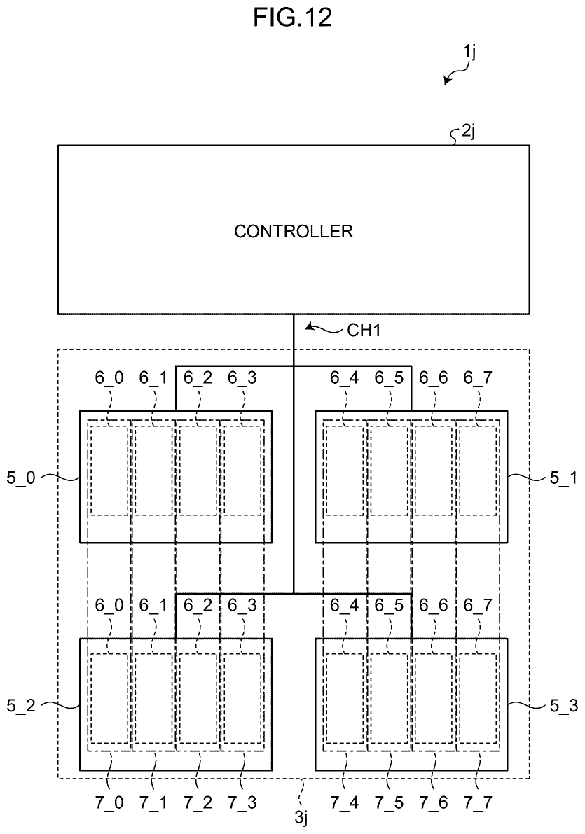

As illustrated in FIG. 12, in the memory system 1j, a nonvolatile memory 3j may include multiple POSs 7 that can execute parallel processing with each other and each existing across two or more memory chips 5. FIG. 12 is a diagram illustrating a configuration of a controller 2j and the nonvolatile memory 3j according to the third embodiment.

The nonvolatile memory 3j includes multiple memory chips 5_0 to 5_3. In FIG. 12, a configuration in which the nonvolatile memory 3j includes the four memory chips 5_0 to 5_3 is exemplified, but the number of memory chips 5 included in the nonvolatile memory 3j may be two to three, or may be five or more.

The memory chip 5_0 includes multiple memory areas 6_0 to 6_3. The memory chip 5_1 includes multiple memory areas 6_4 to 6_7. The memory chip 5_2 includes multiple memory areas 6_0 to 6_3. The memory chip 5_3 includes multiple memory areas 6_4 to 6_7.

The nonvolatile memory 3j includes multiple POSs 7_0 to 7_7. The multiple POSs 7_0 to 7_7 corresponds to a unit in which parallel processing can be mutually performed. The controller 2j can access the multiple POSs 7_0 to 7_3 in parallel. Each POS 7 is also called a bank. In FIG. 12, a configuration in which the nonvolatile memory 3j includes the eights POSs 7_0 to 7_3 is exemplified, but the number of POSs 7 included in the nonvolatile memory 3j may be two to seven, or may be nine or more.

The POS 7_0 is a parallel processing unit existing across the memory chip 5_0 and the memory chip 5_2. The POS 7_0 includes the memory area 6_0 of the memory chip 5_0 and the memory area 6_0 of the memory chip 5_2.

The POS 7_1 is a parallel processing unit existing across the memory chip 5_0 and the memory chip 5_2. The POS 7_1 includes the memory area 6_1 of the memory chip 5_0 and the memory area 6_1 of the memory chip 5_2.

The POS 7_2 is a parallel processing unit existing across the memory chip 5_0 and the memory chip 5_2. The POS 7_2 includes the memory area 6_2 of the memory chip 5_0 and the memory area 6_2 of the memory chip 5_2.

The POS 7_3 is a parallel processing unit existing across the memory chip 5_0 and the memory chip 5_2. The POS 7_3 includes the memory area 6_3 of the memory chip 5_0 and the memory area 6_3 of the memory chip 5_2.

The POS 7_4 is a parallel processing unit existing across the memory chip 5_1 and the memory chip 5_3. The POS 7_4 includes the memory area 6_4 of the memory chip 5_1 and the memory area 6_4 of the memory chip 5_3.

The POS 7_5 is a parallel processing unit existing across the memory chip 5_1 and the memory chip 5_3. The POS 7_5 includes the memory area 6_5 of the memory chip 5_1 and the memory area 6_5 of the memory chip 5_3.

The POS 7_6 is a parallel processing unit existing across the memory chip 5_1 and the memory chip 5_3. The POS 7_6 includes the memory area 6_6 of the memory chip 5_1 and the memory area 6_6 of the memory chip 5_3.

The POS 7_7 is a parallel processing unit existing across the memory chip 5_1 and the memory chip 5_3. The POS 7_7 includes the memory area 6_7 of the memory chip 5_1 and the memory area 6_7 of the memory chip 5_3.

The controller 2j can manage the nonvolatile memory 3j in a unit of the multiple POSs 7_0 to 7_7 for the garbage collection.

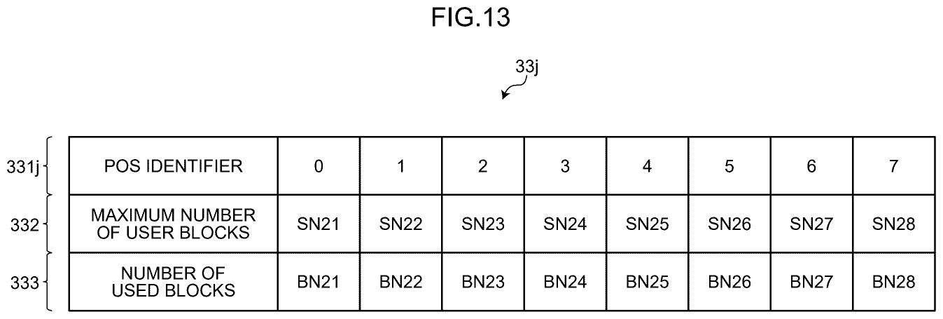

The controller 2j may perform the garbage collection using a block management table 33j as illustrated in FIG. 13, in place of the block management table 33 (refer to FIG. 3). FIG. 13 is a diagram illustrating a data structure of the block management table 33j.

In the block management table 33j, identifiers of POSs 7, the maximum numbers of user blocks, and the numbers of used blocks are associated with the multiple POSs 7_0 to 7_7. The block management table 33j includes a POS identifier field 331j in place of the chip identifier field 331 (refer to FIG. 3). In the POS identifier field 331j, identifiers of the POSs 7 are recorded. Except for this, the block management table 33j is similar to the block management table 33 of the first embodiment.

By referring to the block management table 33j, the controller 2j can recognize the maximum number of user blocks and the number of used blocks that correspond to an identifier of a POS 7. And the controller 2j can obtain a usage ratio from the maximum number of user blocks and the number of used blocks.

Regarding the POS 7_0 with a POS identifier “0”, the maximum number of user blocks is “SN21” and the number of used blocks is “BN21”. From these numbers, a usage ratio can be obtained as (BN21)/(SN21).

Regarding the POS 7_1 with a POS identifier “1”, the maximum number of user blocks is “SN22” and the number of used blocks is “BN22”. From these numbers, a usage ratio can be obtained as (BN22)/(SN22).

Regarding the POS 7_7 with a POS identifier “7”, the maximum number of user blocks is “SN28” and the number of used blocks is “BN28”. From these numbers, a usage ratio can be obtained as (BN28)/(SN28).

It should be noted that an operation of the memory system 1j in the garbage collection is similar to an operation in which a “memory chip” is replaced with a “POS” in the description given with reference to FIGS. 4 and 5.

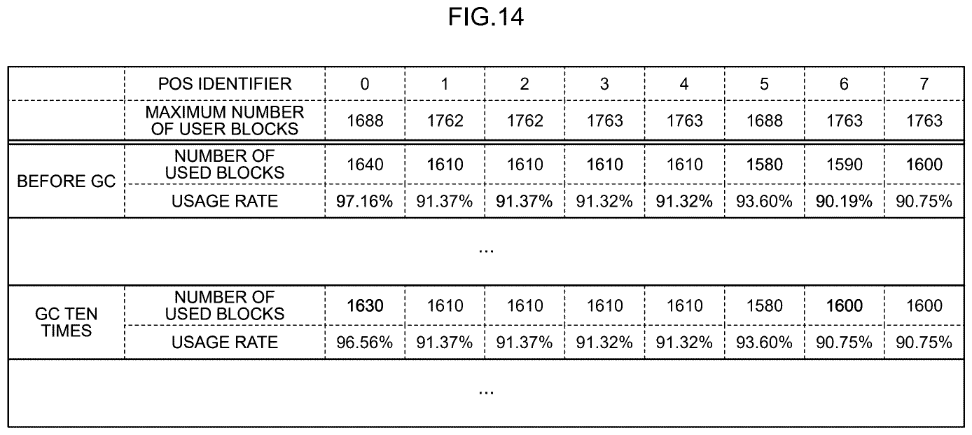

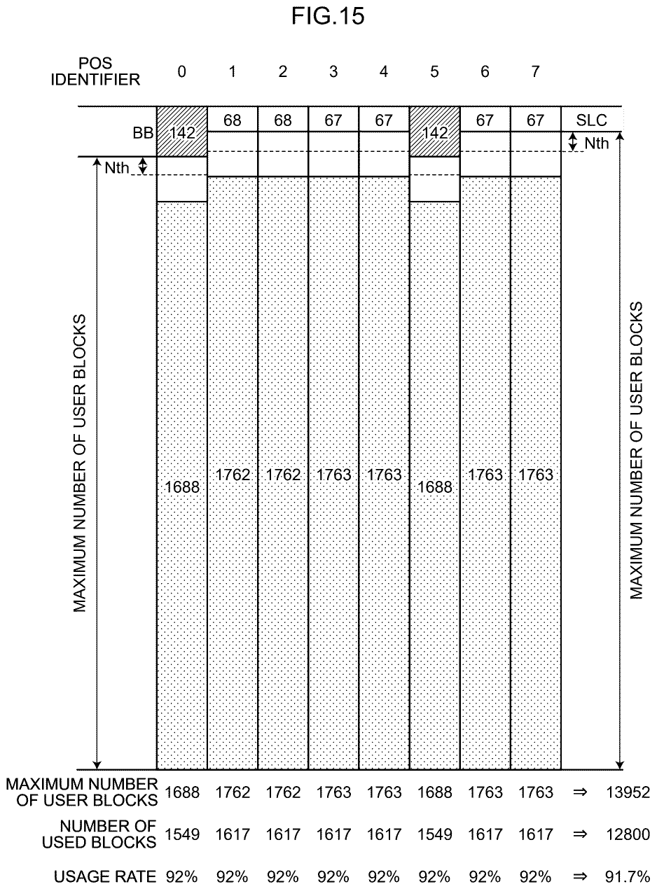

Further, as illustrated in FIGS. 14 and 15, a use case of GC destination search processing of the memory system 1j differs from that in the first embodiment in the following point. FIGS. 14 and 15 are diagrams each illustrating a use case of the GC destination search processing of the memory system 1j according to the third embodiment.

In the state “before GC” illustrated in FIG. 10, the numbers of vacant blocks of multiple POSs 7_0, 7_1, 7_2, 7_3, 7_4, 7_5, 7_6, and 7_7 are 1688−1640=48, 1762−1610=152, 1762−1610=152, 1763−1610=153, 1763−1610=153, 1688−1580=108, 1763−1590=173, and 1763−1600=163, respectively.

Among the multiple POSs 7_0 to 7_7, the POS 7_0 having the number of vacant blocks that is smaller than a threshold value (for example, 100) is determined to be a GC source.

As illustrated in “before GC”, in a state in which GC has not been performed, usage ratios of the multiple POSs 7_0, 7_1, 7_2, 7_3, 7_4, 7_5, 7_6, and 7_7 are 97.16%, 91.37%, 91.37%, 91.32%, 91.32%, 93.60%, 90.19%, and 90.75%, respectively.

Among the multiple POSs 7_0 to 7_7, the POS 7_6 having the minimum usage ratio is determined to be a GC destination.

The controller 2j collects effective data from a block in the POS 7_0 that has been made inefficient, and rewrites the collected effective data into the POS 7_6. The controller 2j erases the block in the POS 7_0 that has been made inefficient, and makes the block into a free block.

By repeating similar processing ten times, as indicated in “GC ten times” , a state in which GC has been performed ten times is caused. In this state, the usage ratios of the multiple POSs 7_0, 7_1, 7_2, 7_3, 7_4, 7_5, 7_6, and 7_7 are 96.56%, 91.37%, 91.37%, 91.32%, 91.32%, 93.60%, 90.75%, and 90.75%, respectively.

A difference between the maximum usage ratio and the minimum usage ratio in the state in which GC has not been performed is 97.16−90.19=6.97 (%). A difference between the maximum usage ratio and the minimum usage ratio in the state in which GC has been performed ten times is 96.56−90.75=5.81 (%).

In other words, by the controller 2j performing GC ten times, a difference between the maximum usage ratio and the minimum usage ratio in the multiple POSs 7_0 to 7_7 decreases, and usage ratios are uniformized.

If the GC is further performed, as illustrated in FIG. 15, the usage ratios of the multiple POSs 7_0 to 7_7 become 92% and can become almost equal. In FIG. 15, the usage states of the POSs 7_0 to 7_7 are indicated as bar graphs. In FIG. 15, a vertical axis indicates the number of blocks, and a horizontal axis indicates a POS identifier.

Regions “142” in the POSs 7_0 and 7_5 are made inaccessible as bad blocks BB. In each of the POSs 7_0 and 7_5, “1688” corresponding to the total number of blocks excluding the number of bad blocks “100” is the maximum number of user blocks.

Regions “68” in the POSs 7_1 and 7_2 are made inaccessible as being a part of the management information storage region 31 (refer to FIG. 1). In each of the POSs 7_1 and 7_2, “1762” corresponding to the total number of blocks excluding the number of blocks “68” of the management information storage region is the maximum number of user blocks.

Regions “67” in the POSs 7_3, 7_4, 7_6, and 7_7 are made inaccessible as being a part of the management information storage region 31 (refer to FIG. 1). In each of the POSs 7_3, 7_4, 7_6, and 7_7, “1763” corresponding to the total number of blocks excluding the number of blocks “67” of the management information storage region is the maximum number of user blocks.

In each of the POSs 7_0 to 7_7, a part indicated by dot hatching corresponds to the number of used blocks. A white part in each of the POSs 7_0 to 7_7 corresponds to the number of vacant blocks. A part existing above a dotted line in the white part in each of the POSs 7_0 to 7_7 corresponds to the threshold value Nth of the number of vacant blocks at which the GC is executed. As illustrated in FIG. 15, in the memory system of the third embodiment, the number of blocks existing between a part indicated by dot hatching, and a dotted line indicating a threshold value becomes equal, and margins in the number of blocks up to the GC executed become equal. With this configuration, it is possible to equalize the frequency of executing GC among multiple POSs 7_0 to 7_7.

In other words, by using a usage ratio as a criterion for determining a GC destination, a POS 7 with a large number of bad blocks becomes less likely to be selected as a GC destination because a usage ratio is high even if the number of used blocks is small. The frequency of executing GC is reduced. Furthermore, a POS 7 with a smaller number of bad blocks becomes more likely to be selected as a GC destination because a usage ratio is low even if the number of used blocks is large. For this reason, it becomes possible to suppress an increase in the number of times of writing/erasing in a POS 7, and it is possible to prolong a product lifetime.

As described above, in the third embodiment, in the memory system 1j, the controller 2j determines a POS 7 serving as a movement destination of data in the garbage collection, among multiple POSs 7 in accordance with the respective usage ratios of the multiple POSs 7. Accordingly, it is possible to uniformize the respective usage ratios of the multiple POSs 7, and equalize the frequency of executing garbage collection among the multiple POSs 7. Consequently, it is possible to equalize the number of times of writing/erasing among the multiple POSs 7, and equalize the respective exhaustion degrees of the multiple POSs 7. Accordingly, it is possible to make the lifetime of the memory system 1j longer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory including a plurality of management units; and
a controller configured to:
manage the plurality of management units; and
determine a first management unit that is a movement destination of data in garbage collection, among the plurality of management units in accordance with respective usage ratios of the plurality of management units.

2. The memory system according to claim 1,
wherein the controller is configured to:
calculate the respective usage ratios of the plurality of management units according to number of used blocks and maximum number of user data blocks; and
determine a management unit having the minimum usage ratio among the plurality of management units, as the first management unit.

3. The memory system according to claim 1,
wherein the controller is configured to:
calculate the respective usage ratios of the plurality of management units according to number of used pages and upper limit number of pages, and
determine a management unit having the minimum usage ratio among the plurality of management units, as the first management unit.

4. The memory system according to claim 2,
wherein the controller is configured to
calculate the usage ratio by dividing the number of used blocks by the maximum number of user data blocks for each of the plurality of management units.

5. The memory system according to claim 3,
wherein the controller is configured to
calculate the usage ratio by dividing the number of used pages by the upper limit number of pages for each of the plurality of management units.

6. The memory system according to claim 1,
wherein the nonvolatile memory includes a plurality of chips, and
the controller is further configured to respectively manage the plurality of chips as the plurality of management units.

7. The memory system according to claim 1,
wherein the nonvolatile memory includes a plurality of chips, and
the controller is further configured to respectively manage a plurality of parallel processing units in the chips as the plurality of management units.

8. The memory system according to claim 1,
wherein the nonvolatile memory includes a plurality of chips, and
the controller is further configured to respectively manage a plurality of parallel processing units each existing across the two or more chips, as the plurality of management units.

9. The memory system according to claim 1,
wherein the controller is configured to determine a management unit having a vacant data capacity that is a first threshold value or less, among the plurality of management units, as the first management unit.

10. The memory system according to claim 1,
wherein the controller is configured to determine a management unit having a used data amount that is a second threshold value or more, among the plurality of management units, as the first management unit.

11. The memory system according to claim 9,
wherein the controller is configured to determine a management unit having number of vacant blocks that is a first threshold number of blocks or less, among the plurality of management units, as the first management unit.

12. The memory system according to claim 9,
wherein the controller is configured to determine a management unit having number of used blocks that is a second threshold number of blocks or more, among the plurality of management units, as the first management unit.

13. The memory system according to claim 9,
wherein the controller is configured to determine a management unit having number of blank pages that is a first threshold number of pages or less, among the plurality of management units, as the first management unit.

14. The memory system according to claim 9,
wherein the controller is configured to determine a management unit having number of used pages that is a second threshold number of pages or more, among the plurality of management units, as the first management unit.

15. The memory system according to claim 2,
wherein the controller is configured to calculate the usage ratio by referring to a table including the maximum numbers of user data blocks and the numbers of used blocks of the respective plurality of management units.

16. The memory system according to claim 3,
wherein the controller is configured to calculate the usage ratio by referring to a table including the upper limit numbers of pages and the numbers of used pages of the respective plurality of management units.

17. The memory system according to claim 15,
wherein the controller is configured to update the table for each access to the nonvolatile memory, and stores the updates table into the nonvolatile memory every first time.

18. The memory system according to claim 16,
wherein the controller is configured to update the table for each access to the nonvolatile memory, and stores the updates table into the nonvolatile memory every first time.

19. The memory system according to claim 15,
wherein the controller is configured to update the table for each access to the nonvolatile memory, and stores the updates table into the nonvolatile memory at a timing of shutdown.

20. The memory system according to claim 16,
wherein the controller is configured to update the table for each access to the nonvolatile memory, and stores the updates table into the nonvolatile memory at a timing of shutdown.
